(19) United States
(12) Patent Application Publication
(10) Pub. No.: US 2016/0369955 A1
(43) Pub. Date: Dec. 22, 2016

(54) ENHANCED COLOR RENDERING LENS FOR WHITE LEDS

(71) Applicant: CoreLed Systems, LLC, Livonia, MI (US)

(72) Inventors: John Kahl, Troy, MI (US); Derek Mallory, Northville, MI (US)

(73) Assignee: CoreLed Systems, LLC, Livonia, MI (US)

(21) Appl. No.: 15/187,350

(22) Filed: Jun. 20, 2016

Related U.S. Application Data
(60) Provisional application No. 62/182,716, filed on Jun. 22, 2015.

(51) Int. Cl. F21V 5/04; G02B 1/04; F21V 9/16

(52) U.S. Cl. CPC F21K 9/64; F21V 5/04; F21V 9/16; G02B 1/041; F21Y 2115/10

(57) ABSTRACT

An optical element for use with a white LED to absorb blue light and re-emit warmer light is made of an admixture of an optically transmissive polymeric material, a first luminescent compound that predominantly absorbs light at wavelengths between 380 nm and 580 nm and predominantly re-emits light at wavelengths between 620 nm and 740 nm, and a second luminescent compound that predominantly absorbs light at wavelengths between 380 nm and 490 nm and predominantly re-emits light at wavelengths between 495 nm and 590 nm. The optical element, which may be a lens for defracting light into a desired beam pattern, eliminates substantially all blue light emitted from the white LED and re-emits a warmer light having a color temperature below 3000 Kelvin and a color rendering index (CRI) above 80.

### CROSS-REFERENCE TO RELATED APPLICATIONS

This application claims the benefit of U.S. Provisional Application No. 62/182,716 filed Jun. 22, 2015, which is incorporated herein by reference.

### FIELD OF THE DISCLOSURE

This disclosure relates to an optical lens for white LEDs that absorbs light at higher frequencies and re-emits light at lower frequencies to provide improved color rendering.

### BACKGROUND OF THE DISCLOSURE

White LEDs have the advantage of producing illuminescence equivalent to an incandescent bulb using a fraction (typically about one-fourth to one-sixth) of the power required for an incandescent bulb. LEDs have the further advantage of having a useful life several times as long as a typical incandescent bulb.

However, most white lighting LEDs use a blue-emitting diode with a phosphor layer over the diode to convert some of the blue light to broadband amber. The resulting light spectrum has a narrow blue spike of relatively high intensity and a broad hump stretching from blue to red. Generally, cool white LEDs have less phosphor and are more power efficient, but tend to have a lower color rendering index. Warm white LEDs have more phosphor and provide better color rendering, but tend to be less power efficient. White LEDs produce very little deep red light, and, therefore, are not well suited for certain lighting applications where a warmer light (around 2700 K) exhibiting good color rendering is desired. Color rendering refers to the ability of a light source to give objects a color that is comparable to daylight or white incandescent light. White LEDs tend to give illuminated objects a blue hue, with red colors having a grey appearance.

For many retail, restaurant service, and other environments, more natural lighting having a higher color rendering index (typically about 80 or higher) is preferred, such as to give foods a more pleasant appearance.

### SUMMARY OF THE DISCLOSURE

The optical lenses and optical filters disclosed are used for modifying the spectrum of light from a white LED to increase the warmth (reduce the color temperature) and color rendering index (CRI) of the light, without substantially reducing the total illuminescence.

In certain aspects of this disclosure, the optical lenses and optical filters are comprised of an optically transmissive polymeric material, a red fluorescent dye, and a green or yellow fluorescent dye. The dyes are substantially homogenously dispersed in the optically transmissive polymeric material.

In particular aspects of this disclosure, the red fluorescent dye predominantly absorbs light at wavelengths between 380 nm and 580 nm, and predominantly re-emits light at wavelengths between 620 nm and 740 nm; and the green or yellow dye predominantly absorbs light at wavelengths between 380 nm and 490 nm, and predominantly re-emits light at wavelengths between 495 nm and 590 nm.

The light emitted from a white LED and passing through the lenses or filters of this disclosure provides increased color rendering (i.e., a CRI greater than 80, or a CRI greater than 85), and warmer light (a color temperature less than 3000 Kelvin, or less than 2000 Kelvin), as compared with unfiltered, unmodified light emitted from the same white LEDs.

Light fixtures or luminaires in accordance with this disclosure include a warm white LED or a cool white LED, and an optical lens or optical filter disposed over the LED such that light emitted from the LED passes through the lens or filter of this disclosure.

### BRIEF DESCRIPTION OF THE DRAWINGS

FIG. 1 is a perspective view of a luminaire in accordance with this disclosure.

FIG. 2 is a graph illustrating the light spectrum of a typical white LED.

FIG. 3 is a graph illustrating the spectrum of light from the typical white LED of FIG. 2 that has passed through an optical element of this disclosure.

### DETAILED DESCRIPTION

The optically transmissive polymeric materials disclosed herein can be shaped into lens members that focus or disperse light, shaped for use as a color (wavelength) filtering element, or used as a coating or encapsulant on a light source (e.g., an LED). The optically transmissive polymeric materials disclosed herein can also be used in the fabrication of reflective elements. For example, a color-filtering reflector can be made by molding an appropriately shaped component and applying a reflective metalized film layer to a facet of the component.

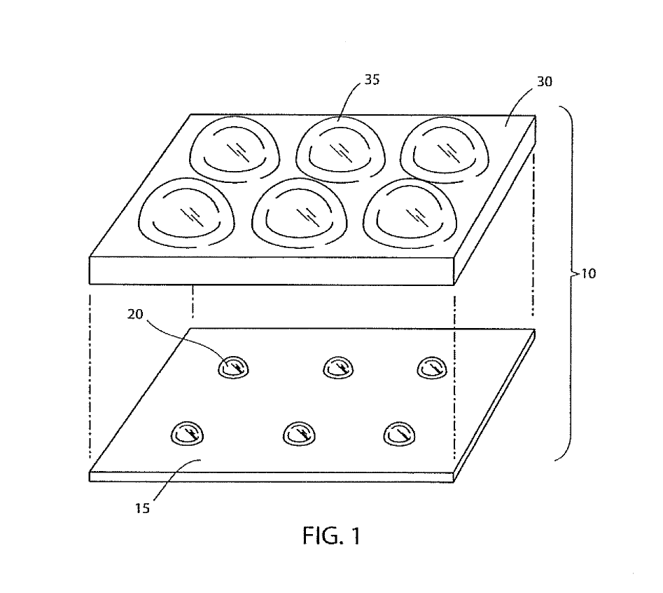

Shown in FIG. 1 is an example of a luminaire 10 in accordance with this disclosure. The luminaire 10 can, for example, comprise a circuit board 15 on which white LEDs 20 are mounted, and a lens member 30 having integrally formed lens elements 35 that are shaped to defract light. A filter or other non-defracting optical member can be used in certain aspects of this disclosure.

The optically transmissive polymeric material is any moldable thermoplastic or thermosettable material into which the fluorescent dyes can be dispersed, and which can subsequently be shaped and solidified to form a solid lens or other object capable of transmitting visible light. Suitable optically transmissive polymeric materials include highly transmissive materials such as acrylic polymers (e.g., polymethylmethacrylate), butyrates (e.g., cellulose acetate butyrate), polycarbonates (e.g., those sold under the “Lexan” brand), transparent silicones, glycol modified polyethylene terephthalate, polystyrene, polystyrene acrylonitrile (SAN), polymethylpentene, polyamide, polyacrylate, polysulfone, polystyrene-co-butadiene, polycyclohexylmethacrylate, polyallyldiglycol carbonate, polyethersulfone, polychlorotrifluoroethylene, polyvinylidene fluoride, polyetherimide, and polysiloxanes.

The red fluorescent dye is a compound that is capable of absorbing visible light in the blue and green regions of the visible light spectrum from about 380 nm to about 580 nm and re-emitting visible light at wavelengths from 620 nm to 740 nm. The red fluorescent dye can be a compound uniformly dispersed in the optically transmissive polymeric material and which is stable in admixture with the optically transmissive polymeric material. The red fluorescent dye can be selected from compounds that achieve the desired absorption of blue or green light (about 380 nm to about 580 nm wavelengths) and re-emission of longer wavelength light (620 nm to 740 nm) in a highly efficient manner (i.e., nearly complete conversion of the absorbed light to higher wavelength light with very little or no heat generation) and without significantly interfering with the optical transmissivity of the composite material (i.e., an admixture of the polymeric material, the dyes and any other additives, such as stabilizers). An example of a suitable red fluorescent dye that can be employed in the lenses and moldable compositions of this disclosure is perylene red (perylene-3,4,9,10-tetracarboxylic dianhydride). An effective amount of perylene red or other red fluorescent dye(s) in the moldable composition that may be used to make a lens in accordance with this disclosure is from about 0.005 parts by weight per 100 parts by weight of the optically transmissive polymeric material to about 0.2 parts by weight per 100 parts by weight (pph) of the optically transmissive polymeric material (e.g., 0.01 to 0.1 pph, or 0.02 to 0.1 pph). Higher or lower amounts of perylene red or other red fluorescent dye(s) can be used, although excessive amounts could adversely affect transmissivity, cost and/or processability, and very low amounts might not be sufficiently effective.

The green or yellow fluorescent dye is a compound that is capable of absorbing visible light in the blue region of the visible light spectrum from about 380 nm to about 490 nm and re-emitting light at wavelengths from 495 nm to 590 nm (green is about 495 nm to about 570 nm, and yellow is about 570 nm to about 590 nm). The green or yellow fluorescent dye can be a compound uniformly dispersed in the optically transmissive polymeric material and which is stable in admixture with the optically transmissive polymeric material. The green or yellow fluorescent dye can be selected from compounds that achieve the desired absorption of blue light and re-emission of green or yellow light (495 nm to 590 nm) in a highly efficient manner (i.e., nearly complete conversion of the absorbed light to higher wavelength light with very little or no heat generation) and without significantly interfering with the optical transmissivity of the composite material (i.e., an admixture of the polymeric material, the dyes, and any other additives, such as stabilizers). An example of a suitable green or yellow fluorescent dye that can be used in the lenses, filters and moldable compositions of this disclosure is perylene yellow. An effective amount of perylene yellow or other yellow fluorescent dye(s) that can be used to make a lens in accordance with this disclosure is from about 0.005 parts by weight per 100 parts by weight of the optically transmissive polymeric material to about 0.2 parts by weight per 100 parts by weight (pph) of the optically transmissive polymeric material (e.g., 0.01 pph to 0.1 pph or 0.02 pph to 0.1 pph). Higher or lower amounts of perylene yellow or other yellow fluorescent dye(s) can be used, although excessive amounts might adversely affect transmissivity, cost and/or processability, and very low amounts might not be sufficiently effective.

The lenses, filters and other articles prepared from the moldable composition of this disclosure can achieve at least 70%, 80% or 85% transmission of visible light having a wavelength greater than 500 nm, and at least 60%, 70% or 80% conversion of light energy having a wavelength from 360 nm to 500 nm to visible light having a wavelength greater than 500 nm.

The term “blue light” refers to the short wavelength blue region of photopic light in the 380 nm to 490 nm range. The term “green light” refers to a region of photopic light in the 490 nm to 580 nm range. The phosphor conversion re-emission in the lens can boost the overall photopic efficiency moving the short wavelength blue light toward the center of the photopic range, which peaks at 555 nm. The emission light will typically have wavelengths above 500 rim and mix with the original LED emission spectrum for additional spectrum fill that boosts the CRI (Color Rendering Index), improving the quality of light and eliminating the short wavelength blue spectrum.

The optical elements (e.g., filters, lenses, and other articles) prepared from the moldable compositions of this disclosure can be molded or otherwise shaped to refract light, such as into converging or diverging beams (i.e., shape the light into a desired beam pattern).

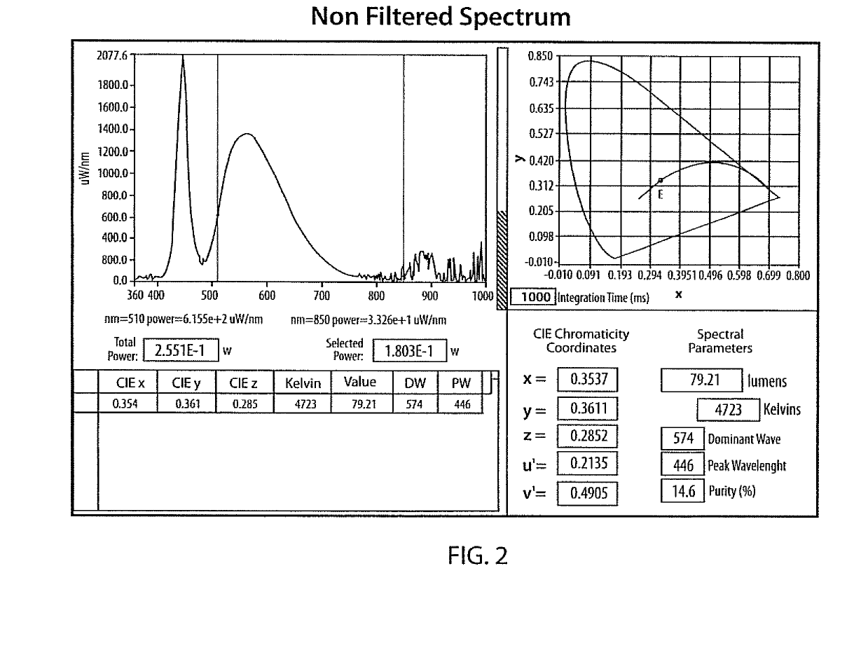

The emission spectrum for a typical white LED is shown in FIG. 2. A substantial amount of energy is emitted in a narrow blue band between about 410 nm and 480 nm, with the warmer band between about 490 nm and 750 nm having a peak irradiance of about 1350 μW (nm)².

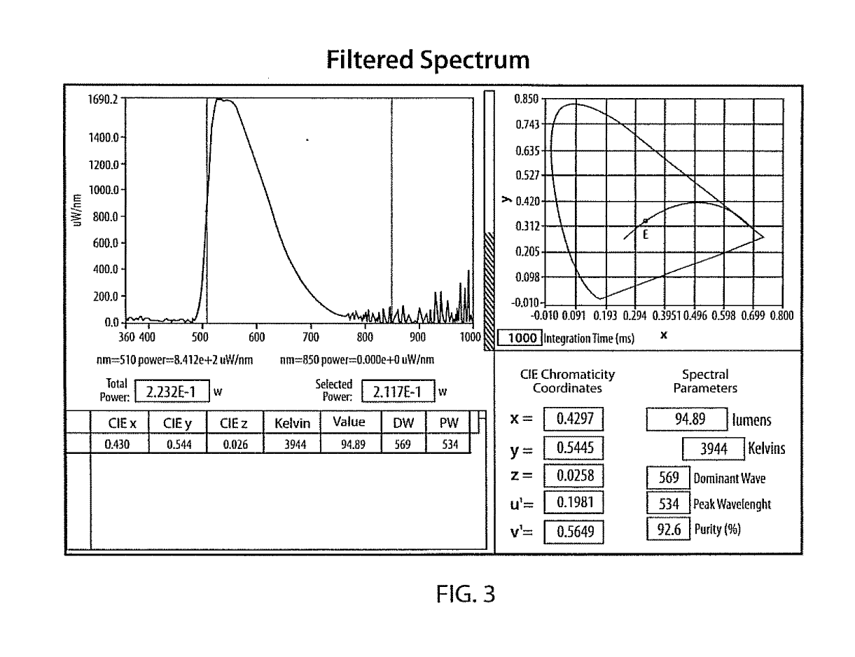

The emission spectrum for light from the white LED of FIG. 2 passing through an optical element in accordance with this disclosure comprising a blend of polymethyl methacrylate, 0.01 pph perylene red and 0.01 pph perylene yellow is shown in FIG. 3. Essentially all of the light in the blue band between 410 nm and 480 nm has been absorbed and re-emitted at a longer wavelength to slightly broaden the warmer light band and increase the peak irradiance at about 1690 μW/(nm)². The optical element increases the CRI to a value greater than 80 or 85, and reduces the color temperature to less than 3000 Kelvin or less than 2000 Kelvin.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

What is claimed is:

1. An optical element comprising:
an optically transmissive polymeric material;
a red fluorescent dye; and
a green or yellow fluorescent dye.

2. The optical element of claim 1, which is shaped to collect light and refract the light to form a beam pattern.

3. The optical element of claim 1, in which the optically transmissive polymeric material comprises an acrylic polymer.

4. The optical element of claim 1, in which the optically transmissive polymeric material comprises polymethylmethacrylate.

5. The optical element of claim 1, in which the optically transmissive polymeric material comprises a polycarbonate.

6. The optical element of claim 1, in which the red fluorescent dye is perylene red.

7. The optical element of claim 1, in which the green or yellow fluorescent dye is perylene yellow.

8. The optical element of Claim I, which absorbs blue light from a beam of light from a white LED and re-emits longer wavelength light to reduce the color temperature below 3000 Kelvin.

9. An optical element, comprising:
an optically transmissive polymeric material;
a first luminescent compound that predominantly absorbs light at wavelengths between 380 nm and 580 nm, and predominantly re-emits light at wavelengths between 620 nm and 740 nm; and
a second luminescent compound that predominantly absorbs light at wavelengths between 380 nm and 490 nm, and predominantly re-emits light at wavelengths between 495 and 590 nm.

10. The optical element of claim 9, which is shaped to collect light and refract the light to form a beam pattern.

11. The optical element of claim 9, in which the optically transmissive polymeric material comprises an acrylic polymer.

12. The optical element of claim 9, in which the optically transmissive polymeric material comprises polymethylmethacrylate.

13. The optical element of claim 9, in which the optically transmissive polymeric material comprises a polycarbonate.

14. The optical element of claim 9, in which the red fluorescent dye is perylene red.

15. The optical element of claim 9, in which the green or yellow fluorescent dye is perylene yellow.

16. The optical element of claim 9, which absorbs blue light from a beam of light from a white LED and re-emits longer wavelength light to reduce the color temperature below 3000 Kelvin.

17. A luminaire comprising:
a white LED mounted on a substrate; and
an optical element covering the white LED, the optical element made of a blend of an optically transmissive polymeric material, a first luminescent compound that predominantly absorbs light at wavelengths between 380 nm and 580 nm, and predominantly re-emits light at wavelengths between 620 nm and 740 nm; and a second luminescent compound that predominantly absorbs light at wavelengths between 380 nm and 490 nm, and predominantly re-emits light at wavelengths between 495 nm and 590 nm.

18. The luminaire of claim 17, in which the optical element is shaped to collect light and refract the light to form a beam pattern.

19. The luminaire of claim 17, in which the optical element is made of a polymethylmethacrylate or polycarbonate.

20. The luminaire of claim 19, in which the red fluorescent dye is perylene red and the green or yellow fluorescent dye is perylene yellow.
